(19) United States
(12) Patent Application Publication
(10) Pub. No.: US 2012/0002172 A1
(43) Pub. Date: Jan. 5, 2012

(54) LIGHT SOURCE APPARATUS AND PROJECTION DISPLAY APPARATUS

(75) Inventors: Takashi Ikeda, Higashiosake-City (JP); Hideyuki Kanayama, Uji-City (JP); Masutaka Inoue, Hirakata-City (JP); Hiroki Hamada, Hirakata-City (JP)

(73) Assignee: SANYO ELECTRIC CO., LTD., Osaka (JP)

(21) Appl. No.: 13/173,419

(22) Filed: Jun. 30, 2011

(30) Foreign Application Priority Data
Jun. 30, 2010 (JP) 2010-149492

(51) Int. Cl. G03B 21/14; G02B 5/18; F21V 9/14

(52) U.S. Cl. 353/20; 362/19; 359/558

(57) ABSTRACT

A light source apparatus according to an embodiment includes: a light source that emits narrow-band exciting light; a polarization adjusting element that adjusts a polarization state of the exciting light; a light guide element capable of changing a direction of the exciting light according to the polarization state adjusted by the polarization adjusting element; and a luminous body which is provided on an optical path of the exciting light guided by the light guide element, and which emits predetermined component light excited by the exciting light.

### CROSS REFERENCE TO RELATED APPLICATIONS

This application is based upon and claims the benefit of priority from prior Japanese Patent Application No. 2010-149492, filed on Jun. 30, 2010; the entire contents of which are incorporated herein by reference.

### BACKGROUND OF THE INVENTION

1. Field of the Invention

The present invention relates to a light source apparatus and a projection display apparatus including a light source configured to emit narrow-band exciting light, and a luminous body configured to emit predetermined component light excited by the exciting light.

2. Description of the Related Art

Conventionally, projection display apparatuses have been known which have a light source, an imager configured to modulate light emitted from the light source, and a projection unit configured to project the light emitted from the imager onto a projection surface.

Here, projection display apparatuses have been proposed which have a luminous body configured to emit red component light, green component light, blue component light, and the like by using light emitted from a light source as exciting light (for example, Japanese Patent Application Publication No. 2010-085740). Specifically, multiple kinds of luminous bodys configured to emit color components of light, respectively, are provided on a color wheel, which is rotated to cause the luminous body to emit the color components of light in a time division manner.

However, since the color wheel needs to be mechanically rotated, a trouble associated with the rotation of the color wheel may occur in the above-described projection display apparatuses.

### SUMMARY OF THE INVENTION

Alight source apparatus of a first aspect comprising:

a light source (light source 10) that emits narrow-band exciting light; a polarization adjusting element (first polarization adjusting element 30 or second polarization adjusting element 50) that adjusts a polarization state of the exciting light; a light guide element (first diffraction element 40 or second diffraction element 60) capable of changing a direction of the exciting light according to the polarization state adjusted by the polarization adjusting element; and a luminous body (luminous body 90R or luminous body 90 G) which is provided on an optical path of the exciting light guided by the light guide element and which emits predetermined component light excited by the exciting light.

A light source apparatus of a second aspect comprising: a light source (light source 10) that emits narrow-band exciting light; a diffraction element (first diffraction element 40 or second diffraction element 60) capable of changing a direction of the exciting light by diffracting the exciting light; and a luminous body (luminous body 90R or luminous body 90 G) which is provided on an optical path of the exciting light guided by the diffraction element, and which emits predetermined component light excited by the exciting light.

In the first aspect or the second aspect, the light source apparatus, further comprising: a rod integrator (rod integrator 80) having dichroic films (dichroic film 81R, dichroic film 81G or dichroic film 81B) which reflects the predetermined component light emitted from the luminous body. The rod integrator has a light reflection side surface (light reflection side surface 82) which reflects the predetermined component light reflected by the dichroic film, and guides the predetermined component light in a longitudinal direction of the rod integrator, while reflecting the predetermined component light on the light reflection side surface. The luminous body is provided on the light reflection side surface.

In the first aspect or the second aspect, the rod integrator is provided with a cooling unit (heat sink 110) that cools the rod integrator.

A projection display apparatus of third aspect comprising: a light source that emits narrow-band exciting light; a polarization adjusting element that adjusts a polarization state of the exciting light; a light guide element capable of changing a direction of the exciting light according to the polarization state adjusted by the polarization adjusting element; a luminous body which is provided on an optical path of the exciting light guided by the light guide element, and which emits predetermined component light excited by the exciting light; an imager that modulates the predetermined component light emitted from the luminous body; and a projection unit that projects the predetermined component light emitted from the imager.

A projection display apparatus of fourth aspect comprising: a light source that emits narrow-band exciting light; a diffraction element capable of changing a direction of the exciting light by diffracting the exciting light; a luminous body which is provided on an optical path of the exciting light guided by the diffraction element, and which emits predetermined component light excited by the exciting light; an imager that modulates the predetermined component light emitted from the luminous body; and a projection unit that projects the predetermined component light emitted from the imager.

### BRIEF DESCRIPTION OF THE DRAWINGS

FIG. 1 is a diagram showing a projection display apparatus 100 according to a first embodiment.

FIG. 2 is a diagram showing a diffraction element according to the first embodiment.

FIG. 3 is a diagram showing the diffraction element according to the first embodiment.

FIG. 4 is a diagram showing a control of red component light R according to the first embodiment.

FIG. 5 is a diagram showing a control of green component light G according to the first embodiment.

FIG. 6 is a diagram showing a control of blue component light B according to the first embodiment.

FIG. 7 is a diagram showing a projection display apparatus 100 according to Modification 1.

FIG. 8 is a diagram showing a projection display apparatus 100 according to Modification 2.

FIG. 9 is a diagram showing a projection display apparatus 100 according to Modification 3.

### DETAILED DESCRIPTION OF THE EMBODIMENTS

Hereinafter, light source apparatus and projection display apparatuses according to embodiments of the present invention will be described with reference to the drawings. Note that, in the following description of the drawings, same or similar reference signs denote same or similar elements and portions.

In addition, it should be noted that the drawings are schematic and ratios of dimensions and the like are different from actual ones. Therefore, specific dimensions and the like should be determined in consideration of the following description. Moreover, the drawings also include portions having different dimensional relationships and ratios from each other.

### Outline of Embodiments

First, a light source apparatus according to an embodiment includes: a light source that emits narrow-band exciting light; a polarization adjusting element that adjusts a polarization state of the exciting light; a light guide element capable of changing a direction of the exciting light according to the polarization state adjusted by the polarization adjusting element; and a luminous body which is provided on an optical path of the exciting light guided by the light guide element, and which emits predetermined component light excited by the exciting light.

According to this embodiment, the light guide element is capable of changing the direction of the exciting light according to the polarization state adjusted by the polarization adjusting element. Accordingly, there is no need to mechanically rotate the color wheel, resulting in improvement in reliability.

Secondly, a light source apparatus according to another embodiment include: a light source that emits narrow-band exciting light; a diffraction element capable of changing a direction of the exciting light by diffracting the exciting light; and a luminous body which is provided on an optical path of the exciting light guided by the diffraction element, and which emits predetermined component light excited by the exciting light.

According to this embodiment, the diffraction element is capable of changing the direction of the exciting light by diffracting the exciting light. Accordingly, there is no need to mechanically rotate the color wheel, resulting in improvement in reliability.

### First Embodiment

### (Projection Display Apparatus)

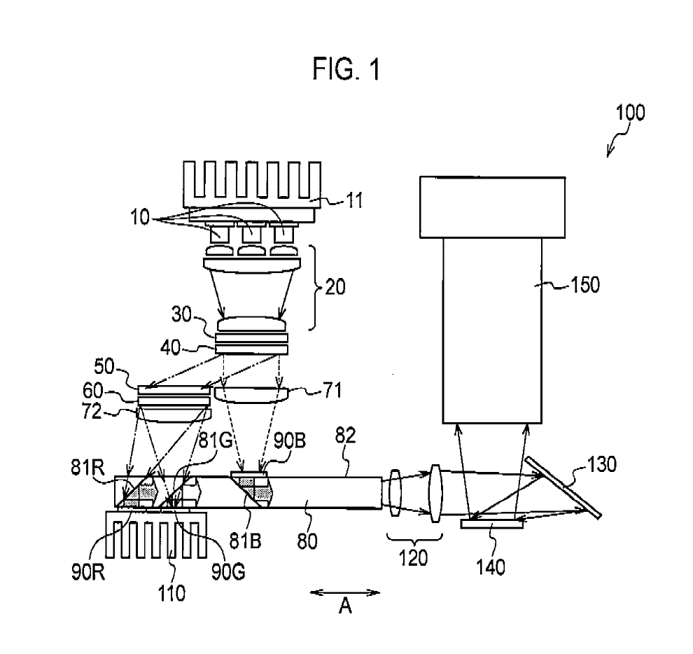

Hereinafter, a projection display apparatus according to a first embodiment will be described with reference to the drawings. FIG. 1 is a diagram showing a projection display apparatus 100 according to the first embodiment.

As shown in FIG. 1, the projection display apparatus 100 include a light source 10, a heat sink 11, a lens group 20, a first polarization adjusting element 30, a first diffraction element 40, a second polarization adjusting element 50, a second diffraction element 60, a lens 71, a lens 72, a rod integrator 80, a luminous body 90R, a luminous body 90G, a diffusion plate 9013, a heat sink 110, a lens group 120, a mirror 130, a DMD 140, and a projection unit 150.

The light source 10 emits narrow-band exciting light. The light source 10 may be, for example, a LD (Laser Diode) or a LED (Light Emitting Diode). In the first embodiment, the narrow-band exciting light is blue component light B.

The heat sink 11 is additionally provided to the light source 10. The heat sink 11 is an example of a cooling unit configured to cool the light source 10. The cooling unit configured to cool the light source 10 may be a liquid cooling device or an air cooling device.

The lens group 20 condenses the exciting light emitted from the light source 10. For example, the lens group 20 condenses the exciting light onto the first polarization adjusting element 30.

The first polarization adjusting element 30 adjusts the polarization state of the exciting light. Specifically, the first polarization adjusting element 30 adjusts the polarization state of the exciting light according to the value of a voltage applied to the first polarization adjusting element 30.

For example, the first polarization adjusting element 30 adjusts all the components in exciting light emitted from the first polarization adjusting element 30 into the P polarization component. Alternatively, the first polarization adjusting element 30 adjusts all the components in the exciting light emitted from the first polarization adjusting element 30 into the S polarization component. Note that, the first polarization adjusting element 30 may adjust the ratio of each of the P polarization component and the S polarization component in the exciting light emitted from the first polarization adjusting element 30 in a range from 0 to 100%.

The first diffraction element 40 is capable of adjusting the direction of the exciting light emitted from the first diffraction element 40 according to the polarization state of the exciting light incident on the first diffraction element 40. Here, the first diffraction element 40 is capable of adjusting the direction of the exciting light by diffracting the exciting light.

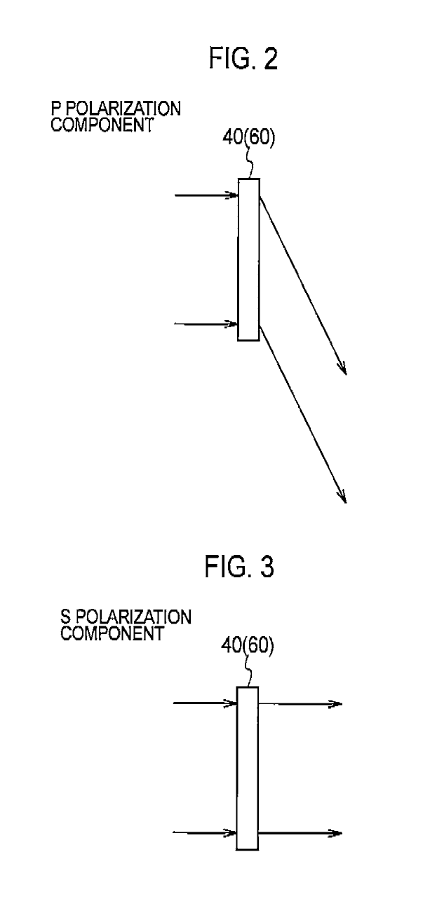

For example, the first diffraction element 40 deflects the direction of the P polarization component in the exciting light incident on the first diffraction element 40, as shown in FIG. 2. On the other hand, the first diffraction element 40 does not deflects the direction of the S polarization component in the exciting light incident on the first diffraction element 40, as shown in FIG. 3. It should be noted that when both the P polarization component and the S polarization component are included, the first diffraction element 40 divides the exciting light into two directions.

The second polarization adjusting element 50 adjusts the polarization state of the exciting light. Specifically, the second polarization adjusting element 50 adjusts the polarization state of the exciting light according to the value of a voltage applied to the second polarization adjusting element 50.

For example, the second polarization adjusting element 50 adjusts all the components in the exciting light emitted from the second polarization adjusting element 50 into the P polarization component. Alternatively, the second polarization adjusting element 50 adjusts all the components in the exciting light emitted from the second polarization adjusting element 50 into the S polarization component. Note that, the second polarization adjusting element 50 may adjust the ratio of each of the P polarization component and the S polarization component in the exciting light emitted from the second polarization adjusting element 50 in a range from 0 to 100%.

The second diffraction element 60 is capable of adjusting the direction of the exciting light emitted from the second diffraction element 60 according to the polarization state of the exciting light incident on the second diffraction element 60. Here, the second diffraction element 60 is capable of adjusting the direction of the exciting light by diffracting the exciting light.

For example, the second diffraction element 60 deflects the direction of the P polarization component in the exciting light incident on the second diffraction element 60, as shown in FIG. 2. On the other hand, the second diffraction element 60 does not deflects the direction of the S polarization component in the exciting light incident on the second diffraction element 60, as shown in FIG. 3. It should be noted that, when both the P polarization component and the S polarization component are included, the second diffraction element 60 divides the exciting light into two directions.

Note that the second polarization adjusting element 50 and the second diffraction element 60 are provided on an optical path of the exciting light (for example, of the P polarization component) emitted from the first diffraction element 40.

The lens 71 condenses the exciting light (for example, the S polarization component) emitted from the first diffraction element 40. In the first embodiment, the lens 71 condenses the exciting light onto the diffusion plate 90B. Note that the lens 71 is provided on the optical path of the exciting light (for example, of the S polarization component) emitted from the first diffraction element 40.

The lens 72 condenses the exciting light emitted from the second diffraction element 60. In the first embodiment, the lens 72 condenses the exciting light (the S polarization component) emitted from the second diffraction element 60 onto the luminous body 90G. Moreover, the lens 72 condenses the exciting light (the P polarization component) emitted from the second diffraction element 60 onto the luminous body 90R.

The rod integrator 80 is constituted of a transparent member such as a glass member, and has a rod-like shape. The rod integrator 80 includes: a dichroic film 81R configured to reflect red component light R emitted from the luminous body 90R; a dichroic film 81G configured to reflect green component light G emitted from the luminous body 90G; a dichroic film 81B configured to reflect blue component light B emitted from the diffusion plate 90B; and a light reflection side surface 82 configured to reflect the red component light R, the green component light G, and the blue component light B.

The dichroic film 81R reflects predetermined component light (the red component light R) and transmits the other color component light. Accordingly, the dichroic film SIR allows the exciting light (the blue component light B) to exit toward the luminous body 90R, and reflects the red component light 11 emitted from the luminous body 90R.

The dichroic film 81G reflects predetermined component light (the green component light G), and transmits the other color component light. Accordingly, the dichroic film 81G allows the exciting light (the blue component light B) to exit toward the luminous body 90G, and reflects the green component light G emitted from the luminous body 90G.

The dichroic film 81B reflects predetermined component light (the blue component light B), and transmits the other color other color component light. The dichroic film 81B reflects the exciting light (blue component light B), and transmits the red component light R and the green component light G.

In the first embodiment, the rod integrator 80 guides the red component light R, the green component light G, and the blue component light B in a longitudinal direction A of the rod integrator 80, while reflecting the red component light R, the green component light G, and the blue component light B on the light reflection side surface 82.

The luminous body 90R may be a fluorescent body or a phosphor. Specifically, the luminous body 90R emits the red component light R excited by the exciting light (the blue component light B). In the first embodiment, the luminous body 90R is provided on the light reflection side surface 82 of the rod integrator 80. The luminous body 90R is of a reflection type which reflects the red component light R excited by the exciting light (the blue component light B).

The luminous body 90G may be a fluorescent body or a phosphor. Specifically, the luminous body 90G emits the green component light G excited by the exciting light (the blue component light B). In the first embodiment, the luminous body 90G is provided on the light reflection side surface 82 of the rod integrator 80. The luminous body 900 is of a reflection type which reflects the green component light G excited by the exciting light (the blue component light B).

It should be noted that, since the red component light R emitted from the luminous body 90R is diffused, there is no need to diffuse the red component light R again. Likewise, it should be noted that, since the green component light G emitted from the luminous body 900 is diffused, there is no need to diffuse the green component light G again.

The diffusion plate 90B diffuses the exciting light (the blue component light B). The diffusion plate 90B reduces the coherence of the exciting light.

The heat sink 110 is additionally provided to the luminous body 90R and the luminous body 90G. The heat sink 110 is an example of a cooling unit configured to cool the luminous body 90R and the luminous body 90G. The cooling unit configured to cool the luminous body 90R and the luminous body 90G may be a liquid cooling device or an air cooling device.

The lens group 120 condenses light emitted from the rod integrator 80 onto the DMD 140.

The DMD 140 is constituted of multiple micro mirrors, which are movable. Each of the micro mirrors basically corresponds to one pixel. The DMD 140 changes the angle of each of the micro mirrors to perform switching as to whether or not the light is reflected toward the projection unit 150.

The projection unit 150 projects the light (image light) emitted from the DMD 140 onto a projection surface.

It should be noted that, in the first embodiment, a light source apparatus is constituted of the light source 10, the first polarization adjusting element 30, the first diffraction element 40, the second polarization adjusting element 50, the second diffraction element 60, the rod integrator 80, the luminous body 90R, the luminous body 90G, and the diffusion plate 90B. The light source apparatus may have necessary lens groups in addition to these components.

### (Red Component Light R)

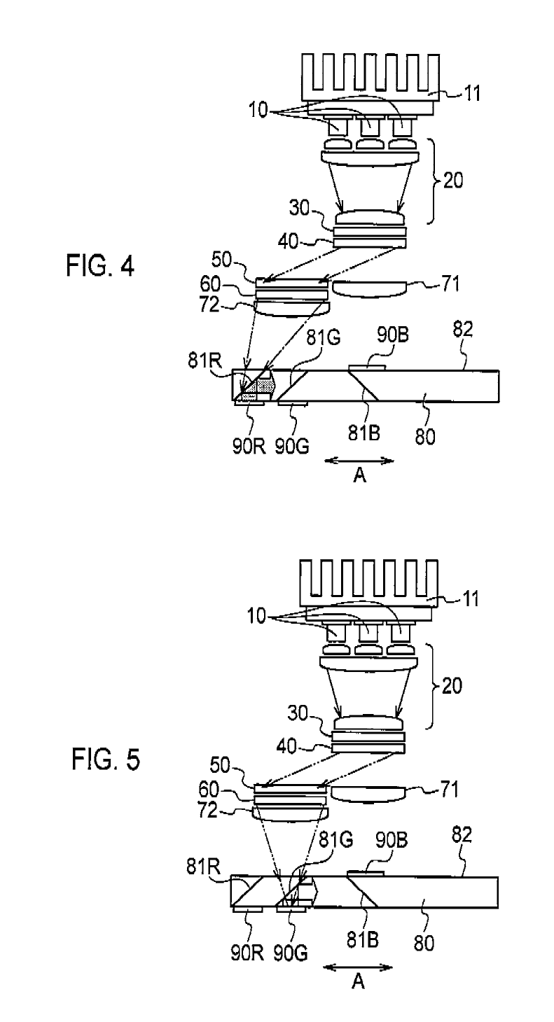

Hereinafter, description will be given of a control of the red component light R according to the first embodiment with reference to FIG. 4. In the control of the red component light R, the first polarization adjusting element 30 adjusts all the components in the exciting light emitted from the first polarization adjusting element 30 into the P polarization Component. Meanwhile, the second polarization adjusting element 50 adjusts all the components in the exciting light emitted from the second polarization adjusting element 50 into the F polarization component.

Accordingly, the first diffraction element 40 changes the direction of the exciting light emitted from the first polarization adjusting element 30 toward the second polarization adjusting element 50 (the second diffraction element 60). The second diffraction element 60 changes the direction of the exciting light emitted from the second polarization adjusting element 50 toward the luminous body 90R.

Note that the red component light R emitted from the luminous body 90R is reflected by the dichroic film 81R, and guided in the longitudinal direction of the rod integrator 80. As a matter of course, the red component light R reflected by the dichroic film 81R is allowed to pass through the dichroic film 81G and the dichroic film 81B.

### (Green Component Light G)

Hereinafter, a control of the green component light G according to the first embodiment will be described with reference to FIG. 5. In the control of the green component light G, the first polarization adjusting element 30 adjusts all the components in the exciting light emitted from the first polarization adjusting element 30 into the P polarization component. Meanwhile, the second polarization adjusting element 50 adjusts all the components in the exciting light emitted from the second polarization adjusting element 50 into the S polarization component.

Accordingly, the first diffraction element 40 changes the direction of the exciting light emitted from the first polarization adjusting element 30 toward the second polarization adjusting element 50 (the second diffraction element 60). The second diffraction element 60 does not change the direction of the exciting light emitted from the second polarization adjusting element 50, and guides the exciting light toward the luminous body 90G.

Note that the green component light G emitted from the luminous body 90G is reflected by the dichroic film 810, and guided in the longitudinal direction of the rod integrator 80. As a matter of course, the green component light G reflected by the dichroic film 810 is allowed to pass through the dichroic film 81B.

### (Blue Component Light B)

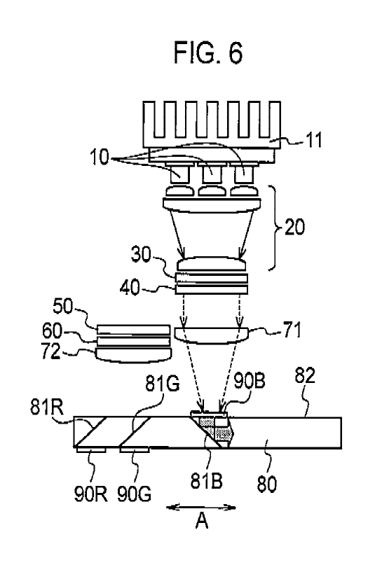

Hereinafter, a control of the blue component light B according to the first embodiment will be descried with reference to FIG. 6. In the control of the blue component light B, the first polarization adjusting element 30 adjusts all the components in the exciting light emitted from the first polarization adjusting element 30 in to the S polarization component.

Accordingly, the first diffraction element 40 does not change the direction of the exciting light emitted from the first polarization adjusting element 30, and guides the exciting light toward the diffusion plate 90B.

Note that, the blue component light B emitted from the diffusion plate 90B is reflected by the dichroic film 81B, and is guided in the longitudinal direction of the rod integrator 80. As a matter of course, there is no need to control the second polarization adjusting element 50 in the control of the blue component light B.

### (Other Color Component Light)

As described above, in the first embodiment, the polarization state of the exciting light is adjusted by the first polarization adjusting element 30 and the second polarization adjusting element 50 so that the direction of the exciting light can be changed by the first diffraction element 40 and the second diffraction element 60. This also enables controls of yellow component light, cyan component light, and magenta component light.

First, the yellow component light can be generated by synthesizing the red component light R and the green component light G. In the control of the yellow component light, the first polarization adjusting element 30 adjusts all the components in the exciting light emitted from the first polarization adjusting element 30 into the P polarization component. Meanwhile, the second polarization adjusting element 50 adjusts the exciting light emitted from the second polarization adjusting element 50 that includes the P polarization component and the S polarization component at a ratio of 50:50.

Accordingly, the first diffraction element 40 changes the direction of the exciting light emitted from the first polarization adjusting element 30 toward the second polarization adjusting element 50 (the second diffraction element 60). Meanwhile, the second diffraction element 60 divides the exciting light emitted from the second polarization adjusting element 50 into light toward the luminous body 90R and light toward the luminous body 90G at a ratio of 50:50.

Secondly, the cyan component light can be generated by synthesizing the green component light G and the blue component light B. In the control of the cyan component light, the first polarization adjusting element 30 adjusts the exciting light emitted from the first polarization adjusting element 30 that includes the P polarization component and the S polarization component at a ratio of 50:50. Meanwhile, the second polarization adjusting element 50 adjusts all the contents in the exciting light emitted from the second polarization adjusting element 50 into the S polarization component.

Accordingly, the first diffraction element 40 divides the exciting light emitted from the first polarization adjusting element 30 into the light toward the second polarization adjusting element 50 (the second diffraction element 60) and the light toward the diffusion plate 90B at a ratio of 50:50. Meanwhile, the second diffraction element 60 does not change the direction of the exciting light emitted from the second polarization adjusting element 50, and guides the exciting light toward the luminous body 90G.

Thirdly, the magenta component light can be generated by synthesizing the red component light R and the blue component light B. In the control of the magenta component light, the first polarization adjusting element 30 adjusts the exciting light emitted from the first polarization adjusting element 30 that includes the P polarization component and the S polarization component at a ratio of 50:50. Meanwhile, the second polarization adjusting element 50 adjusts all the components in the exciting light emitted from the second polarization adjusting element 50 into the P polarization component.

Accordingly, the first diffraction element 40 divides the exciting light emitted from the first polarization adjusting element 30 into light toward the second polarization adjusting element 50 (the second diffraction element 60) and light toward the diffusion plate 90B at a ratio of 50:50. Meanwhile, the second diffraction element 60 changes the direction of the exciting light emitted from the second polarization adjusting element 50 toward the luminous body 90R.

Note that, in the controls of half tone component light, such as the yellow component light, the cyan component light, and the magenta component light, a control is made so that the exciting light can contain the P polarization component and the S polarization component at a ratio of 50:50. However, the ratio between the P polarization component and the S polarization component is not limited to 50:50. As a matter of course, the ratio between the P polarization component and the S polarization component can be a predetermined ratio in consideration of the difference in light use efficiency during diffraction or straight traveling in the diffraction elements, the difference in light use efficiency due to the difference in the number of optical elements involved in the transmission, reflection, and the like of the light of each color component, and the difference in emission efficiency among the luminous bodys.

### (Operation and Effects)

In the first embodiment, the first diffraction element 40 (or the second diffraction element 60) is capable of changing the direction of the exciting light according to the polarization state adjusted by the first polarization adjusting element 30 (or the second polarization adjusting element 50). Accordingly, there is no need to mechanically rotate the color wheel, resulting in improvement in reliability.

In the first embodiment, the first diffraction element 40 (or the second diffraction element 60) is capable of dividing the exciting light in multiple directions according to the polarization state adjusted by the first polarization adjusting element 30 (or the second polarization adjusting element 50). Accordingly, the yellow component light, the cyan component light, and the magenta component light can be generated,

### (Modification 1)

Hereinafter, Modification 1 of the first embodiment will be described with reference to the drawings. In the following description, differences from the above-described first embodiment are mainly described.

Specifically, the case where the light source 10 emits the blue component light B as the exciting light is described in the first embodiment, whereas the light source 10 emits ultraviolet light as the exciting light in Modification 1.

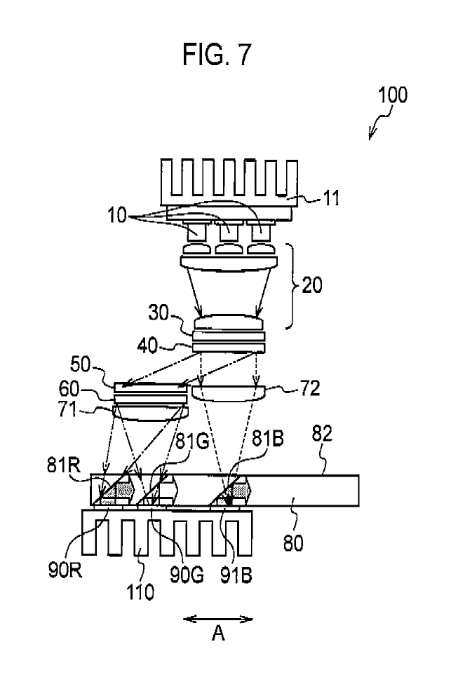

As shown in FIG. 7, the projection display apparatus 100 has a luminous body 91B instead of the diffusion plate 90B. Note that, since the other components are the same as those of FIG. 1, description of the other components is omitted.

The luminous body 91B is a fluorescent body or a phosphor. Specifically, the luminous body 91B emits blue component light B excited by the exciting light (ultraviolet light). In Modification 1, the luminous body 91B is provided on the light reflection side surface 82 of the rod integrator 80. The luminous body 91B is of a reflection type which reflects the blue component light B excited by the exciting light (ultraviolet light).

It should be noted that, since the blue component light B emitted from the luminous body 91B is diffused, there is no need to diffuse the blue component light B again.

In Modification 1, the heat sink 110 cools the luminous body 91B in addition to the luminous body 90G and the luminous body 90R. The heat sink 110 is an example of a cooling unit configured to cool the luminous body 90G, the luminous body 90R, and the luminous body 91B.

### (Modification 2)

Hereinafter, Modification 2 of the first embodiment will be described with reference to the drawings. In the following description, differences from the above-described first embodiment are mainly described.

Specifically, a case where the rod integrator 80 synthesizes the red component light R, the green component light G, and the blue component light B is described in the first embodiment, whereas the rod integrator 80 synthesizes the red component light R, the green component light G, the blue component light B, and yellow component light Ye in Modification 2.

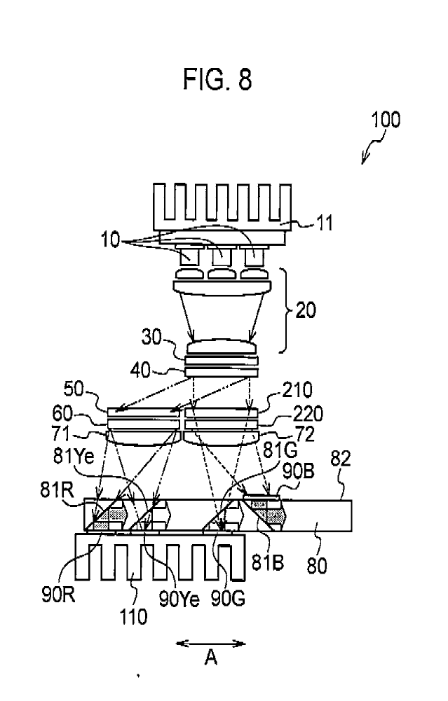

As shown in FIG. 8, the projection display apparatus 100 has a third polarization adjusting element 210, a third diffraction element 220, and a luminous body 90Ye, in addition to the components shown in FIG. 1. Moreover, the rod integrator 80 has a dichroic film 81Ye, in addition to the dichroic film 81B, the dichroic film 81G, and the dichroic film 81B. Note that, since the other components are the same as those in FIG. 1, description of the other components is omitted.

The third polarization adjusting element 210 adjusts the polarization state of the exciting light. Specifically, the third polarization adjusting element 210 adjusts the polarization state of the exciting light according to the value of a voltage applied to the third polarization adjusting element 210.

For example, the third polarization adjusting element 210 adjusts all the components in the exciting light emitted from the third polarization adjusting element 210 into the P polarization component. Alternatively, the third polarization adjusting element 210 adjusts all the components in the exciting light emitted from the third polarization adjusting element 210 into the S polarization component. Note that, the third polarization adjusting element 210 may adjust the ratio of each of the P polarization component and the S polarization component in the exciting light emitted from the third polarization adjusting element 210 in the range from 0 to 100%.

The third diffraction element 220 is capable of adjusting the direction of the exciting light emitted from the third diffraction element 220 according to the polarization state of the exciting light incident on the third diffraction element 220. Here, the third diffraction element 220 is capable of adjusting the direction of the exciting light by diffracting the exciting light.

For example, the third diffraction element 220 does not deflect the direction of the S polarization component in the exciting light incident on the third diffraction element 220. On the other hand, the third diffraction element 220 deflects the direction of the P polarization component in the exciting light incident on the third diffraction element 220, as shown in FIG. 3. It should be noted that when both the P polarization component and the S polarization component are included, the third diffraction element 220 divides the exciting light into two directions.

The luminous body 90Ye is a fluorescent body or a phosphor. Specifically, the luminous body 90Ye emits yellow component light Ye excited by the exciting light (the blue component light B). In the Modification 2, the luminous body 90Ye is provided on the light reflection side surface 82 of the rod integrator 80. The luminous body 90Ye is of a reflection type which reflects the yellow component light Ye excited by the exciting light (the blue component light B).

The dichroic film 81Ye reflects predetermined component light (the yellow component light Ye), and transmits the other color component light. Accordingly, the dichroic film 81Ye allows the exciting light (the blue component light B) to exit toward the luminous body 90Ye, and reflects the yellow component light Ye emitted from the luminous body 90Ye.

### (Control of Color Component Light)

Hereinafter, controls of the red component light R, the green component light G, the blue component light B, and the yellow component light Ye will be described.

First, in the control of the red component light R, the first polarization adjusting element 30 adjusts all the components in the exciting light emitted from the first polarization adjusting element 30 into the P polarization component. Meanwhile, the second polarization adjusting element 50 adjusts all the components in the exciting light emitted from the second polarization adjusting element 30 into the P polarization component.

Accordingly, the first diffraction element 40 changes the direction of the exciting light emitted from the first polarization adjusting element 30 toward the second polarization adjusting element 50 (the second diffraction element 60). Meanwhile, the second diffraction element 60 changes the direction of the exciting light emitted from the second polarization adjusting element 50 toward the luminous body 90R.

Secondly, in the control of the green component light G, the first polarization adjusting element 30 adjusts all the components in the exciting light emitted from the first polarization adjusting element 30 into the S polarization component. Meanwhile, the third polarization adjusting element 210 adjusts all the components in the exciting light emitted from the third polarization adjusting element 210 into the S polarization component.

Accordingly, the first diffraction element 40 does not change the direction of the exciting light emitted from the first polarization adjusting element 30, and guides the exciting light toward the third polarization adjusting element 210 (the third diffraction element 220). Meanwhile, the third diffraction element 220 does not change the direction of the exciting light emitted from the second polarization adjusting element 50, and guides the exciting light toward the luminous body 90G.

Thirdly, in the control of the blue component light B, the first polarization adjusting element 30 adjusts all the contents in the exciting light emitted from the first polarization adjusting element 80 into the S polarization component. Meanwhile, the third polarization adjusting element 210 adjusts all the components in the exciting light emitted from the third polarization adjusting element 210 into the P polarization component.

Accordingly, the first diffraction element 40 does not change the direction of the exciting light emitted from the first polarization adjusting element 30, and guides the exciting light toward the third polarization adjusting element 210 (the third diffraction element 220). Meanwhile, the third diffraction element 220 changes the direction of the exciting light emitted from the second polarization adjusting element 50 toward the diffusion plate 90B.

Fourthly, in the control of the yellow component light Ye, the first polarization adjusting element 30 adjusts all the components in the exciting light emitted from the first polarization adjusting element 30 into the P polarization component. Meanwhile, the second polarization adjusting element 50 adjusts all the components in the exciting light emitted from the second polarization adjusting element 50 into the S polarization component.

Accordingly, the first diffraction element 40 changes the direction of the exciting light emitted from the first polarization adjusting element 30 toward the second polarization adjusting element 50 (the second diffraction element 60). Meanwhile, the second diffraction element 60 does not change the direction of the exciting light emitted from the second polarization adjusting element 50, and guides the exciting light toward the luminous body 90Ye.

### (Modification 3)

Hereinafter, Modification 3 of the first embodiment will be described with reference to the drawings. In the following description, differences from the above-described first embodiment are mainly described.

In the first embodiment, only the light source 10 configured to emit the exciting light (the blue component light B) is provided. In contrast, in Modification 3, another light source configured to emit red component light R is provided in addition to the light source 10 configured to emit the exciting light (the blue component light B).

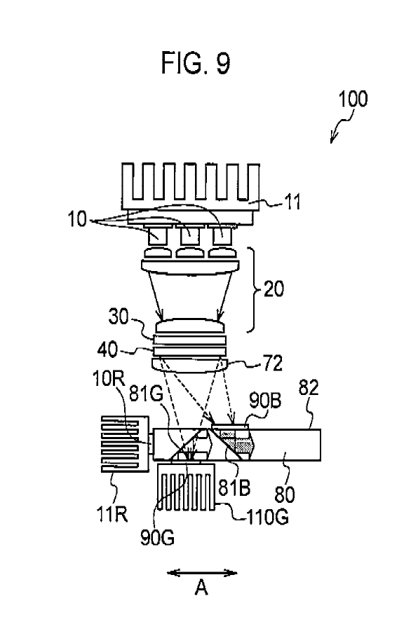

As shown in FIG. 9, the projection display apparatus 100 has a light source 10R configured to emit the red component light R. It should be noted that components unnecessary in Modification 3 (for example, the second polarization adjusting element 50, the second diffraction element 60, and the dichroic film 81R) are omitted in FIG. 9. In addition, since the other components are the same as those in FIG. 1, description of the other components is omitted.

The light source 10R is provided on one end side of the rod integrator 80 in the longitudinal direction A of the rod integrator 80. Note that it is a matter of course that the light source XOR is provided on a side opposite to the DMD 140 with respect to the rod integrator 80.

The red component light R emitted from the light source 10R is guided in the longitudinal direction A of the rod integrator 80, while being reflected on the light reflection side surface 82 of the rod integrator 80.

### (Controls of Color Component Light)

Hereinafter, controls of the green component light G and the blue component light B will be described.

First, in the control of the green component light G, the first polarization adjusting element 30 adjusts all the components in the exciting light emitted from the first polarization adjusting element 30 into the S polarization component. Accordingly, the first diffraction element 40 does not change the direction of the exciting light exiting the first polarization adjusting element 30, and guides the exciting light toward the luminous body 90G.

Secondly, in the control of the blue component light B, the first polarization adjusting element 30 adjusts all the components in the exciting light emitted from the first polarization adjusting element 30 into the F polarization component. Accordingly, the first diffraction element 40 changes the direction of the exciting light emitted from the first polarization adjusting element 30 toward the diffusion plate 90B.

### Other Embodiments

The present invention is described on the basis of the above-described embodiments. However, it should not be understood that the description and drawings which constitute part of this disclosure limit the present invention. From this disclosure, various alternative embodiments, examples, and operation techniques will be easily found by those skilled in the art.

In the embodiments, the DMD 140 is shown as an example of an imager, but embodiments are not limited thereto. The imager may be a single liquid crystal panel or three liquid crystal panels (a red liquid crystal panel, a green liquid crystal panel, and a blue liquid crystal panel). The liquid crystal panels may be of a transmission type or a reflection type.

In the embodiments, the cases where the direction of the exciting light can be changed by combining a polarization adjusting element and a diffraction element are described. However, embodiments are not limited thereto.

Specifically, it is possible to use a light guide element capable of changing the direction of the exciting light according to polarization characteristics of the exciting light. It should be noted that a light guide element should be used instead of the diffraction element, in such a case. For example, it is possible to use, as the light guide element, an element capable of changing the direction of the exciting light according to an applied voltage in a time division manner.

Alternatively, it is possible to use a diffraction element capable of changing the direction of the exciting light not according to polarization characteristics of the exciting light, but according to diffraction characteristics of the exciting light. It should be noted that no polarization adjusting element is necessary in such a case.

What is claimed is:

1. A light source apparatus comprising:
a light source that emits narrow-band exciting light;
a polarization adjusting element that adjusts a polarization state of the exciting light;
a light guide element capable of changing a direction of the exciting light according to the polarization state adjusted by the polarization adjusting element; and
a luminous body which is provided on an optical path of the exciting light guided by the light guide element and which emits predetermined component light excited by the exciting light.

2. A light source apparatus comprising:
a light source that emits narrow-band exciting light;
a diffraction element capable of changing a direction of the exciting light by diffracting the exciting light; and
a luminous body which is provided on an optical path of the exciting light guided by the diffraction element, and which emits predetermined component light excited by the exciting light.

3. The light source apparatus according to claim 1 or 2, further comprising:
a rod integrator having a dichroic film which reflects the predetermined component light emitted from the luminous body, wherein
the rod integrator has a light reflection side surface which reflects the predetermined component light reflected by the dichroic film, and guides the predetermined component light in a longitudinal direction of the rod integrator, while reflecting the predetermined component light on the light reflection side surface, and
the luminous body is provided on the light reflection side surface.

4. The light source apparatus according to claim 3, wherein the rod integrator is provided with a cooling unit that cools the rod integrator.

5. A projection display apparatus comprising:
a light source that emits narrow-band exciting light;
a polarization adjusting element that adjusts a polarization state of the exciting light;
a light guide element capable of changing a direction of the exciting light according to the polarization state adjusted by the polarization adjusting element;
a luminous body which is provided on an optical path of the exciting light guided by the light guide element, and which emits predetermined component light excited by the exciting light;
an imager that modulates the predetermined component light emitted from the luminous body; and
a projection unit that projects the predetermined component light emitted from the imager.

6. A projection display apparatus comprising:
a light source that emits narrow-band exciting light;
a diffraction element capable of changing a direction of the exciting light by diffracting the exciting light;
a luminous body which is provided on an optical path of the exciting light guided by the diffraction element, and which emits predetermined component light excited by the exciting light;
an imager that modulates the predetermined component light emitted from the luminous body; and
a projection unit that projects the predetermined component light emitted from the imager.
